(19) United States
(12) Patent Application Publication
(10) Pub. No.: US 2004/0072543 A1
(43) Pub. Date: Apr. 15, 2004

(54) Superheterodyne transceiver

(76) Inventors: Min-Chuan Wu, Taichung (TW); Yung-Fang Huang, Miaoli (TW)

Correspondence Address: RABIN & Berdo, PC, 1101 14TH STREET, NW, SUITE 500, WASHINGTON, DC, 20005, US

(21) Appl. No.: 10/628,048

(22) Filed: Jul. 28, 2003

(30) Foreign Application Priority Data
Aug. 1, 2002 (TW) 91117352

(51) Int. Cl. H04B 1/38

(52) U.S. Cl. 455/73; 455/333; 455/150.1

(57) ABSTRACT

A superheterodyne transceiver. In the superheterodyne transceiver of the present invention, a front end circuit has a differential pair to output a differential signal. A transformer has a primary side with a tap coupled to ground, two input terminals to receive the differential signal, and a secondary side with an output. A surface acoustic wave filter has an input terminal coupled to the output terminal of the secondary side of the transformer.

### BACKGROUND OF THE INVENTION

1. Field of the Invention

The present invention relates to a transceiver, and in particular to a superheterodyne transceiver with improved conversion efficiency that can easily make a conjugate match with the input impedance of a SAW filter.

2. Description of the Related Art

At present, superheterodyne transceivers are adopted for radio frequency (RF) modules with intermediate frequency (IF) at tens to hundreds of Hz, and most superheterodyne transceivers employ surface acoustic wave (SAW) filters as channel selection filters.

In radio frequency ICs, primary down converters usually employ differential open-collector outputs, but secondary down converters employ a single-ended input. Thus, these ICs not only need to convert two-ended signals into single-ended signals, but must also address coupling effect between the conversion interface circuit and the surface acoustic wave filter.

FIG. 1 shows a conventional conversion interface circuit. Front end circuit 100 includes a low noise amplifier 110, and a mixer 120 with differential open-collector outputs IA and IB. The front end circuit 100 converts the differential signals into a single-end signal by a conversion interface circuit 50 composed of resistor R1, inductors L1 and L10, and capacitors C1, C10 and C20. The conversion interface circuit 50 outputs the single-ended signal to the input of the surface acoustic wave filter 40. The inductor L1 and capacitor C1 are chosen to resonate at as desired IF frequency. The current from the outputs IA and IB are 180 degrees out of phase. The conversion interface circuit 50 must align the signals in phase and output to the single-ended load. Thus, the conversion interface circuit 50 functions as a current combiner. Inductor L10 serves as an output choke to DC power VCC, and capacitor C20 serves as a series DC block to suppress signal interference caused by feeding IF signals into power VCC. In addition, the inductor L10 and capacitor C20 are chosen to form an impedance matching network. Capacitor 10 serves as a DC block, and capacitors C10 and C20 are chosen to match to the input impedance of the surface acoustic wave filter 40. The resistor R1 is chosen to adjust the conversion gain of the mixer 120 and converts the differential output currents from the mixer into a single-ended voltage signal.

Because of modifying impedance matching network, inductor L10 and capacitor C20, to match the input impedance of the SAW filter 40 may affect the resonant frequency of the inductor L1 and capacitor C1, the inductor L1 and capacitor C1 must be chosen again. However, modifying the inductor L1 and capacitor C1 may affect the impedance matching of the inductor L10 and capacitor C20. Thus, since inductors L1 and L10 and capacitors C1 and C20 must be repeatedly modified, they are not easy to be matched, and modifying the inductors L1 and L10 and capacitors C1 and C20 of the conversion interface circuit 50 is time consuming.

FIG. 2 shows another conversion interface circuit. The mixer 120 has differential open-collector outputs IA and IB. The conversion interface circuit 50 converts differential signals into a single-ended signal and outputs to the input of the SAW filter 40. The conversion interface circuit 50 includes a resistor R10, inductors L1 and L2 and capacitors C1, C10 and C20. The parallel inductors L1 and L2 and capacitor C1 are chosen to resonate at the desired IF frequency. The current from the outputs, IA and IB, are 180 degrees out of phase. The conversion interface circuit 50 must align the signals in phase and output to the single-ended load. Capacitors C10 and C20 serve as DC blocks, and the resistor R10 and capacitor C10 are chosen to form an impedance matching network to match the input impedance of the SAW filter 40. Also, inductors L1 and L2 and capacitors C1, C10 and C20 of the circuit shown in FIG. 2 still need to be modified repeatedly.

The circuit routing of the two configurations shown in FIGS. 1 and 2 may affect the conversion efficiency and impedance matching thereof. Especially, the capacitors and inductors must be chosen to resonate at the desired IF frequency. Any parasitic capacitors may prevent the current combine from aligning the differential signals in phase and output the result effectively, and thus degrade the conversion efficiency of the current combiner. Thus, for matching the differential mixer to combine the differential signals, a superheterodyne transceiver matching the differential mixer is needed.

### SUMMARY OF THE INVENTION

Accordingly, an object of the invention is to provide a superheterodyne transceiver in which conversion efficiency and impedance matching of the mixer are not affected by circuit routing. Also, the present invention can easily make a conjugate match with the low resistive and capacitive input impedance of the SAW filter.

In the superheterodyne transceiver of the present invention, a front end circuit has a differential pair to output a differential signal. A transformer has a primary side and a secondary side. The primary side has a tap coupled to ground, and two input terminals to receive the differential signal. The secondary side has an output terminal. A surface acoustic wave filter has an input terminal and an output terminal, the input terminal is coupled to the output terminal of the secondary side of the transformer.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a conventional conversion interface circuit;

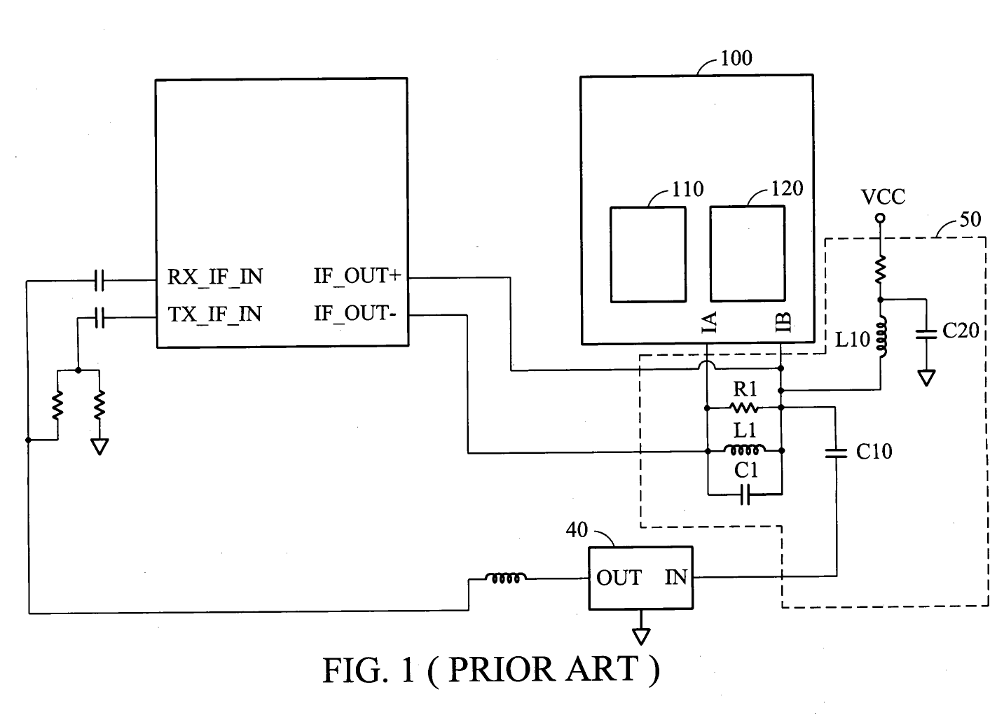

FIG. 2 shows another conventional conversion interface circuit;

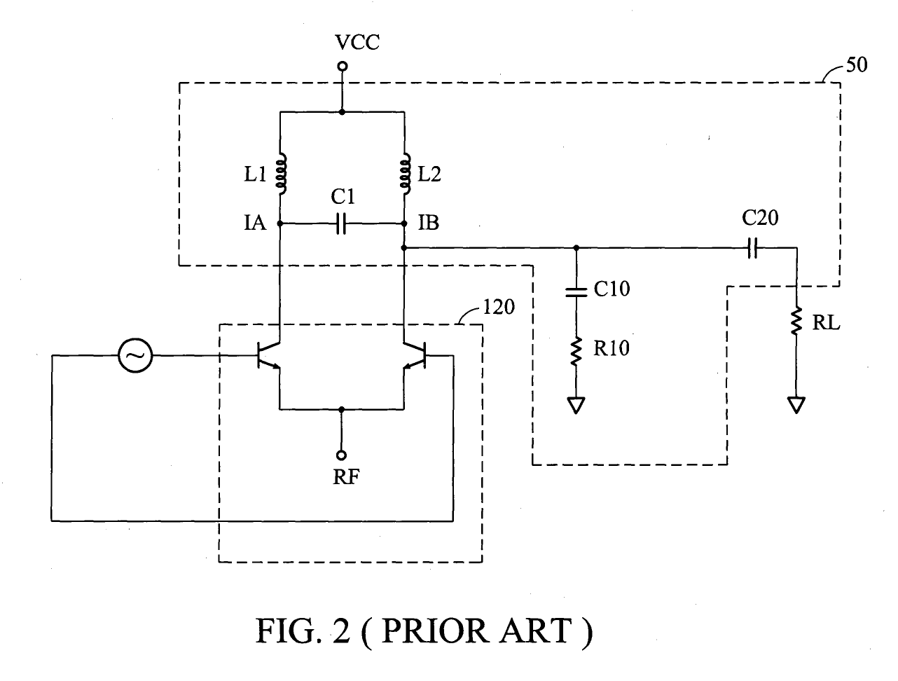

FIG. 3 is a diagram of the superheterodyne transceiver according to the present invention;

FIG. 4 is a circuit diagram of the radio frequency mixer according to the present invention;

FIG. 5 shows a diagram of the transformer;

FIG. 6 shows the structure of the surface acoustic wave filter; and

FIGS. 7A and 7B are equivalent circuit diagrams of the surface acoustic wave filter of the FIG. 6.

### DETAILED DESCRIPTION OF THE INVENTION

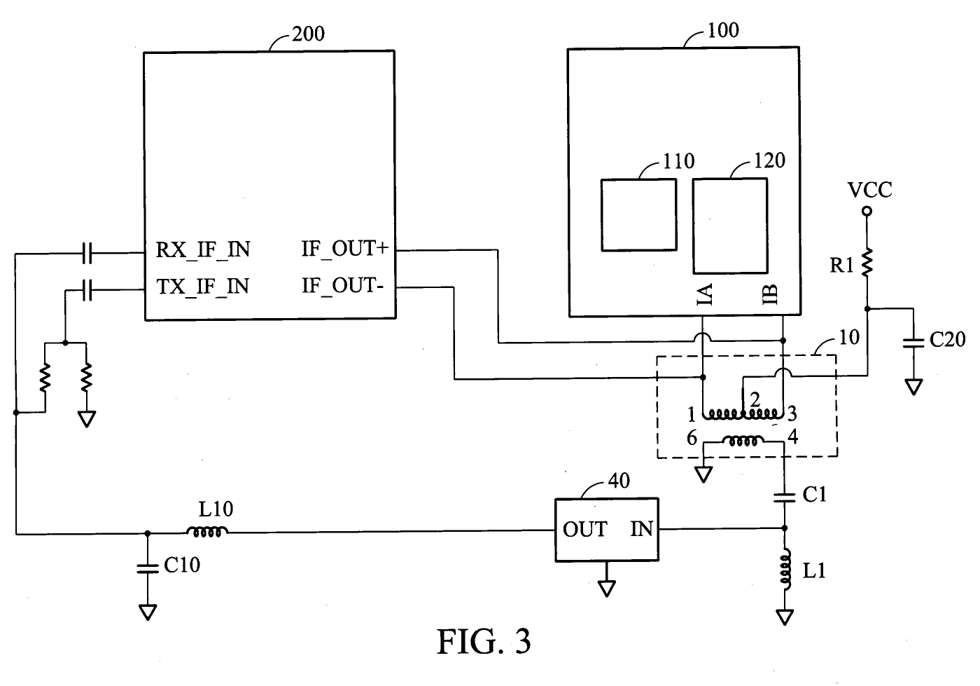

FIG. 3 is a diagram of the superheterodyne transceiver according to the present invention. The superheterodyne transducer includes a front end circuit 100, a transformer 10, a surface acoustic wave (SAW) filter 40, and an intermediate frequency circuit 200. The front end circuit 100 includes a low noise amplifier (LNA) 110 and RF mixer 120, and has differential outputs IA and IB. In this case, the differential outputs IA and IB are the output terminals of the RF mixer 120. The tap 2 of the transformer 10 is coupled to DC bias voltage (VCC) through a resistor R1, and the tap 2 is coupled to ground (GND) through a capacitor C20. The terminals 1 and 3 of the transformer 10 are coupled to the outputs IA and IB respectively. The terminal 4 of the transformer 10 is coupled to the SAW filter 40 through an impedance matching network composed of capacitor C1 and inductor L1. The SAW filter 40 is coupled to the intermediate frequency circuit 200 through an impedance matching network composed of capacitor 10 and inductor L10.

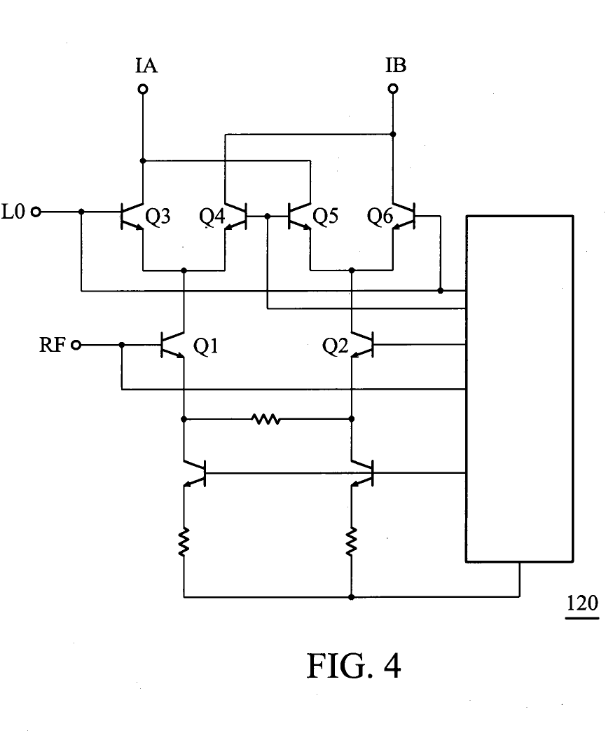

In current trends, the LNA 110 is integrated into the IC package with RF mixer 120 to form a front end circuit 100. FIG. 4 is a circuit diagram of the RF mixer. As shown in FIG. 4, the main portion of the RF mixer 120 may be a double balanced mix of Gilbert Cell. Although the RF mixer 120 is differentially operated, the local oscillation input terminal LO and the radio frequency terminal RF are single-ended input terminals and avoid employing a balun device. Gilbert cells are often employed in integrated circuits. Gilbert cells are not only employed for four quadrant multiplier in analog circuits but also for mixing large signals in switching mode. Gilbert cells can provide high conversion gain, broad bandwidth, low power consumption and are easily fabricated in integrated circuit chips because coupled differential amplifiers. In the core circuit of the Gilbert cell, a differential pair is composed of transistor Q1 and Q2 to receive the signal at the radio frequency input terminal RF. A coupling differential amplifier is composed of transistors Q3, Q4, Q5 and Q6 tied in with transistors Q1 and Q2. The current difference between the output terminals IA and IB of the mixer 120 is ΔI=Iεε×(tan(V1)tan(V2)). If IEE is the bias current of the transistors Q1 and Q2, voltage V1 is the AC voltage at the local oscillation terminal LO, and voltage V2 is the AC voltage at the radio frequency input terminal RF. For applying to mixer 120, voltage V1 is usually a large signal sufficient to operate the transistors Q3˜Q6 in saturation region or off cut region, and the transistors Q3˜Q6 function as a chopper or a switching device. Meanwhile, the transistors Q1 and Q2 coupled to the radio frequency input terminal RF are operated in linear region, and function as a linear amplifier. The emitters of the transistors Q1 and Q2 are regarded as virtual short-circuit for radio frequency signals. The emitters of the transistors Q3˜Q6 are regarded as virtual short-circuit for location oscillation signals. Thus, there is no location oscillation signal present to the transistors Q1 and Q2. Gilbert cell has many good characteristics for repelling spurious signals, such as even harmonics of radio frequency signals and location oscillation signals, isolation between three ports of the radio frequency input RF, location oscillation input LO and IF inputs IA and IB, and the like. The differential current ΔI between the outputs of the mixer, because of the IF signals, causes a load voltage drop across outputs IA and IB. Thus, the outputs IA and IB of the front end circuit are usually in an open-collector configuration and intermediate frequency (IF) signals and the collector bias voltage are adjusted by an external collector load.

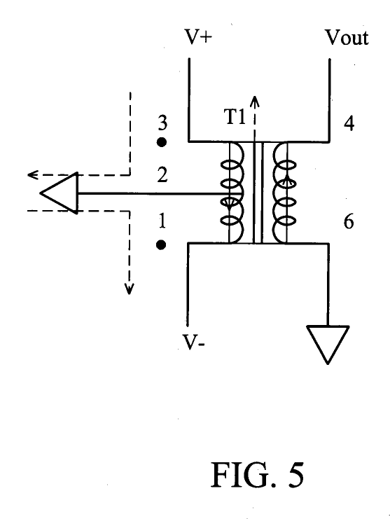

FIG. 5 shows a diagram of the transformer. The tap 2 of the transformer 10 is coupled to a DC bias voltage VCC through a resistor R1, such that the outputs of the mixer are maintained at the appropriate bias voltage. The tap 2 of the transformer 10 is also coupled to ground through a capacitor C20, such that signals at the differential outputs IA and IB form a closed loop. The signals at the differential outputs IA and IB are 180 degrees out of phase, and flow into the terminals 3 and 1 of the transformer 10 respectively. Thus, the magnetic fluxes produced by current from differential outputs IA and IB are added together, and the single-ended signal is obtained at the terminal 4 of the transformer 10 though the magnetic loop. The terminal 2 of the transformer 10 is a tap, and thus primary side can be regard as a combination of two inductive windings. The impedance of the terminal 4 of the transformer 10 is mainly inductive with low resistance because the differential outputs IA and IB are highly resistive.

The operational performance of the surface acoustic wave filter 40 is affected by many factors, such as impedance matching of the input load, impedance matching of the output load, connection quality, in the vicinity of circuits or conductors, layout of printed circuit board and the like. An impedance matching network is an important interface circuit for the mixer 120 and the surface acoustic wave filter 40. Surface acoustic wave filter 40 is a three-ended device, and the load impedance of the input and the output thereof may affect the insertion loss and the amplitude of multi-reflection acoustic wave between two transducers. These two conditions cannot be satisfied at the same time. The insertion loss must be decreased to satisfy the desired gain of the system and preventing from degrading signal-to-noise ratio (SNR). The multi-reflection acoustic wave must be suppressed to obtain signal fidelity and decrease spurious signals. While it has previously been problematic to obtain signal fidelity and to maintain a high capacity of spurious signal rejection at the same time, the impedance network provides a compromise for this.

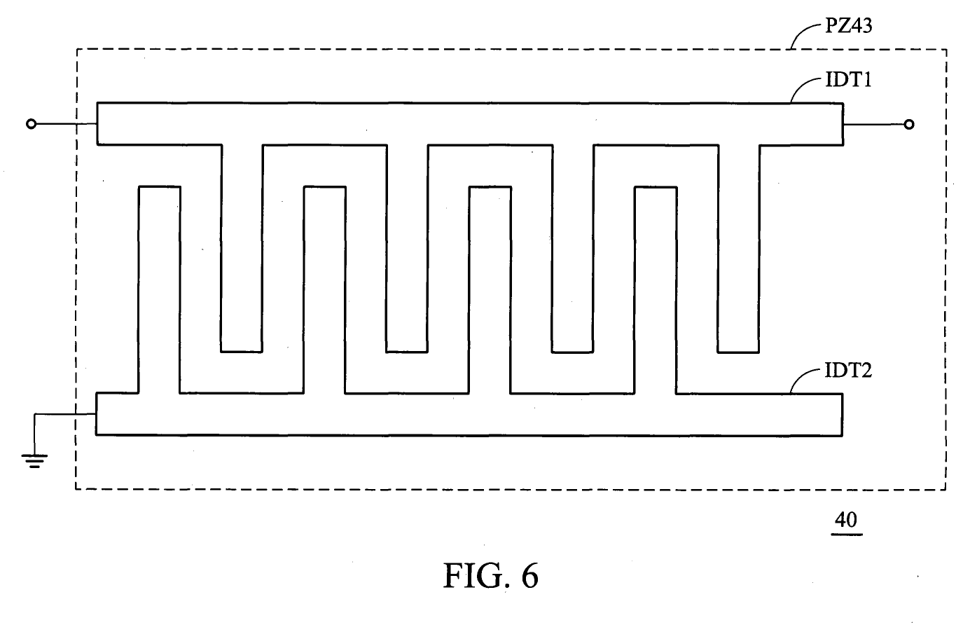

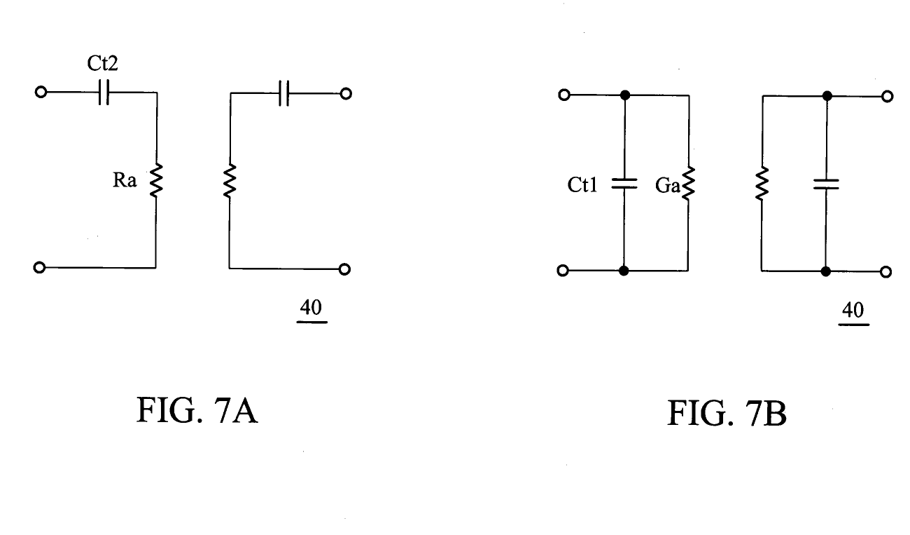

FIG. 6 shows a structural diagram of the surface acoustic wave filter. As shown in FIG. 6, surface acoustic wave filter 40, includes a pair of interdigital transducers IDT1 and IDT2 and piezoelectric dielectric PZ43. The electric characteristics of the surface acoustic wave filter 40 can be regarded as a series equivalent circuit composed of a radiation conductance GA and the interdigital transducer capacitor Ct1, as shown in FIG. 7B. Alternately, the electrical characteristic of the surface acoustic wave filter 40 can be regarded as a parallel equivalent circuit composed of a radiation resistor Ra and the interdigital transducer capacitor Ct2, as shown in FIG. 7A. The capacitor Ct1 of the series equivalent circuit is regarded as equal to the capacitor Ct2 of the parallel equivalent circuit when (ωCt1)²>>Ga² and (1/ωCt2)²>>Ra². The interdigital transducer capacitor Ct1 can be a series reactance or a parallel admittance, and is much larger than the series radiation resistor Ra or the parallel radiation conductance Ga. If this transducer is connected to a resistive load directly, this results in frequency dependent impedance non-matching for the desired wave response. Within the desired wave frequency, it is important to maintain the insertion loss of the SAW filter in an acceptable range and decrease phase and amplitude distortion. Therefore, a series inductor or a parallel inductor is applied to tune the interdigital transducer capacitor Ct1.

The matching method of the present invention is described with reference to FIG. 7B. The inductor L1 shown in FIG. 3 has two purposes, tuning the interdigital transducer capacitor Ct1, and tying in with capacitor C1 to match the radiation conductance Ga to the output impedance of the terminal 4 of the transformer 10. Because the output impedance of the terminal 4 of the transformer 10 is low resistive and inductive, it is especially easy to conjugately match the low resistive and capacitive output impedance of the SAW filter 40.

Therefore, in the superheterodyne transceiver of the present invention, the conversion efficiency and impedance matching of the mixer are not affected by circuit routing. Also, the present invention can easily make a conjugate match to the low resistive and capacitive input impedance of the SAW filter. Thus, the present invention can align the signals from mixer in phase effectively, and then output, thereby improving conversion efficiency.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A superheterodyne transceiver, comprising:
a front end circuit with a differential pair, outputting a differential signal;
a transformer having primary and secondary side, wherein the primary side has a tap coupled to ground and two input terminals for receiving the differential signal, and the secondary side has an output terminal; and
a surface acoustic wave filter having an input terminal coupled to the output terminal of the secondary side, and an output terminal.

2. The superheterodyne transceiver of claim 1, further comprising an intermediate frequency circuit having an input terminal coupled to the output terminal of the surface acoustic wave filter.

3. The superheterodyne transceiver of claim 1, wherein the reactance of the input terminal of the surface acoustic wave filter is essentially capacitive.

4. The superheterodyne transceiver of claim 1, wherein the reactance of the output terminal of the secondary side of the transformer is essentially inductive.

5. The superheterodyne transceiver of claim 1, further comprising a matching circuit coupled between the output terminal of the secondary side of the transformer and the input terminal of the surface acoustic wave filter.

6. The superheterodyne transceiver of claim 1, further comprising a LC matching network coupled between the output terminal of the secondary side of the transformer and the input terminal of the surface acoustic wave filter.

7. The superheterodyne transceiver of claim 1, wherein the tap of the primary side of the transformer couples to the ground through a capacitor.

8. The superheterodyne transceiver of claim 1, wherein the tap of the primary side of the transformer couples to a DC bias voltage through a resistor.

9. The superheterodyne transceiver of claim 1, wherein the front end circuit comprises a mixer with an output terminal as the differential pair of the front end circuit.

10. The superheterodyne transceiver of claim 1, wherein the front end circuit comprises a Gilbert cell.

11. A superheterodyne transceiver, comprising:
a mixer with a differential pair, outputting a differential signal;
a transformer having a primary side with a tap coupled to ground, and a secondary side with an output terminal, wherein the primary side has two input terminals for receiving the differential signal; and
a surface acoustic wave filter having an input terminal coupled to the output terminal of the secondary side, and an output terminal.

12. The superheterodyne transceiver of claim 11, further comprising an intermediate frequency circuit having an input terminal coupled to the output terminal of the surface acoustic wave filter.

13. The superheterodyne transceiver of claim 11, wherein the reactance of the input terminal of the surface acoustic wave filter is essentially capacitive.

14. The superheterodyne transceiver of claim 11, wherein the reactance of the output terminal of the secondary side of the transformer is essentially inductive.

15. The superheterodyne transceiver of claim 11, further comprising a matching circuit coupled between the output terminal of the secondary side of the transformer and the input terminal of the surface acoustic wave filter.

16. The superheterodyne transceiver of claim 11, further comprising a LC matching network coupled between the output terminal of the secondary side of the transformer and the input terminal of the surface acoustic wave filter.

17. The superheterodyne transceiver of claim 11, wherein the tap of the primary side of the transformer couples to the ground through a capacitor.

18. The superheterodyne transceiver of claim 11, wherein the tap of the primary side of the transformer couples to a DC bias voltage through a resistor.

19. The superheterodyne transceiver of claim 11, wherein the mixer comprises a Gilbert cell.
